(19) United States
(12) Patent Application Publication
(10) Pub. No.: US 2010/0252365 A1
(43) Pub. Date: Oct. 7, 2010

(54) Personnel Transfer Device

(76) Inventors: Christian W. Feller, New Iberia, LA (US); Jack C. Broussard, JR., New Iberia, LA (US)

Correspondence Address: LAW OFFICE OF JESSE D. LAMBERT, L.L.C., 406 AUDUBON BLVD., LAFAYETTE, LA, 70503, US

(21) Appl. No.: 12/749,879

(22) Filed: Mar. 30, 2010

Related U.S. Application Data
(60) Provisional application No. 61/165,566, filed on Apr. 1, 2009.

(51) Int. Cl. A62B 1/08; B66C 1/12; A62B 1/16; A62B 35/00

(52) U.S. Cl. 182/231; 182/5

(57) ABSTRACT

A personnel transfer device, of the type commonly used in offshore oil and gas operations, has a means for lowering personnel from the personnel transfer device in a controlled manner, with the personnel transfer device in an elevated position. In one embodiment, the personnel transfer device has an automatic descender device fixed thereto. Such personnel transfer devices are typically lifted by cranes mounted on offshore platforms or drilling rigs, and move personnel from elevated positions on the platform or drilling rig to and from the decks of boats. In the event of a crane failure during the personnel transfer procedure, resulting in the personnel transfer device suspended in the air in an elevated position, personnel that are in the personnel transfer device can use the automatic descender to safely lower themselves from the elevated personnel transfer device to a waiting boat, the water's surface, etc.

### CROSS REFERENCE TO RELATED APPLICATIONS

This regular patent application claims priority to U.S. Provisional Patent Application Ser. No. 61/165566, filed Apr. 1, 2009, for all purposes.

### BACKGROUND—FIELD OF THE INVENTION

This invention relates to apparatus and method used to move personnel and equipment from an elevated location, to a lower location, and vice versa. More particularly, this invention relates to apparatus and method commonly used in offshore oil and gas operations, to move equipment and personnel from a lower location, typically a vessel floating in the water, to an elevated location, typically an elevated structure such as a fixed or floating production facility or drilling rig, which may be elevated at significant heights above the water; and from the elevated location back down to a vessel or the like. Such apparatus have been commonly referred to as “personnel baskets” or “personnel transfer devices” and are generally lifted by a crane mounted on the elevated structure.

### BACKGROUND—RELATED ART

This invention has particular, but not exclusive, application to the offshore oil and gas industry. In more detail, this invention relates to a personnel transfer device, also commonly referred to as a personnel basket, commonly used to move personnel and equipment in offshore work environments to and from vessels and elevated offshore structures. For example, personnel transfer devices known in the art are suspended from a crane on an offshore fixed or floating structure (for example, a drilling rig or production platform), and are used to move personnel (and equipment) from the structure down to a vessel or boat brought alongside the structure. It is understood that such personnel baskets are similarly used to move personnel in a reverse direction, i.e. from the vessel up onto the structure. See, e.g., U.S. Pat. Nos. 2,827,325; 3,827,745; 4,883,301; 7,121,600; and 7,252,315 as examples of existing personnel baskets and personnel transfer devices.

A problem arises when crane failures occur while personnel are suspended in the personnel transfer device, and the transfer device cannot then be moved (it simply remains suspended in place). While not common, when such failures occur the personnel are stuck in the transfer device, perhaps a great distance (50 to 100 feet) above a structure or the surface of the water, for as long as it takes for the crane to be repaired. At times, these repairs may take a number of hours, or even overnight; at other times, bad weather may be brewing, and even relatively short repair times may present danger to the personnel in the transfer device. It is readily appreciated that this is an undesirable situation, and for certain individuals can be the source of extreme anxiety.

As a result, there is a need for providing a means for such personnel to safely exit the personnel transfer device and lower themselves, in a controlled manner, to a lower location, for example the deck of a boat, or a platform, namely a means for lowering personnel in a controlled manner from a personnel transfer device. Broadly, such means for lowering personnel would include:
a length of rope which may be hung off of the personnel transfer device, from which personnel lower themselves by hand-over-hand action;
a length of rope which may be hung off of the personnel transfer device, with the personnel lowering themselves by utilizing a harness around the body, combined with friction devices commonly used rapelling and similar activities; and
in particular, as one of the presently preferred embodiments of the present invention, a controlled descent device (typically comprising a spool with a cable thereon, and a braking system to control spool rotation) is mounted to the personnel transfer device, and personnel use a harness attached to the controlled descent device to lower themselves.

Such controlled descent devices, which in and of themselves are known in the art and are commercially available, permit personnel to lower themselves in a harness (via a cable or rope unwinding from a spool, controlled by a braking mechanism) at a controlled rate from an elevated position.

Therefore, the present invention combines a personnel transfer device with a means for lowering personnel in a controlled manner, to a lower position, particularly but not exclusively a controlled descent device. In the described setting, the personnel in the transfer device can safely lower themselves to a platform or the ground, a waiting vessel, or even into the water.

### BRIEF DESCRIPTION OF THE DRAWINGS

FIG. 1 is a perspective view of one embodiment of a combined personnel transfer device/controlled descent device of the present invention.

FIG. 2 is a partial section view of one embodiment of the controlled descent device component of the invention, shown in the protective hood, with the release rope, security tabs, and bottom plate shown.

FIG. 3 is a partial section view of one embodiment of the invention, showing the controlled descent device within its protective hood mounted in the peak of the personnel transfer device.

FIGS. 4 and 5 are partial section views of another embodiment of the invention, comprising a personnel transfer device having a rigid connection between the top and bottom rings.

FIG. 6 shows a person being lowered from the personnel transfer device, via a harness connected to the cable of the controlled descent device.

FIG. 7 shows another embodiment of the invention.

FIG. 8 shows a friction device for use in another embodiment of the invention.

### DETAILED DESCRIPTION OF VARIOUS EMBODIMENTS OF THE INVENTION

Several embodiments of the present invention will be described in sufficient detail to enable those having ordinary skill in the relevant art field to understand how same is manufactured and used.

### Personnel Transfer Devices or “Baskets” Generally

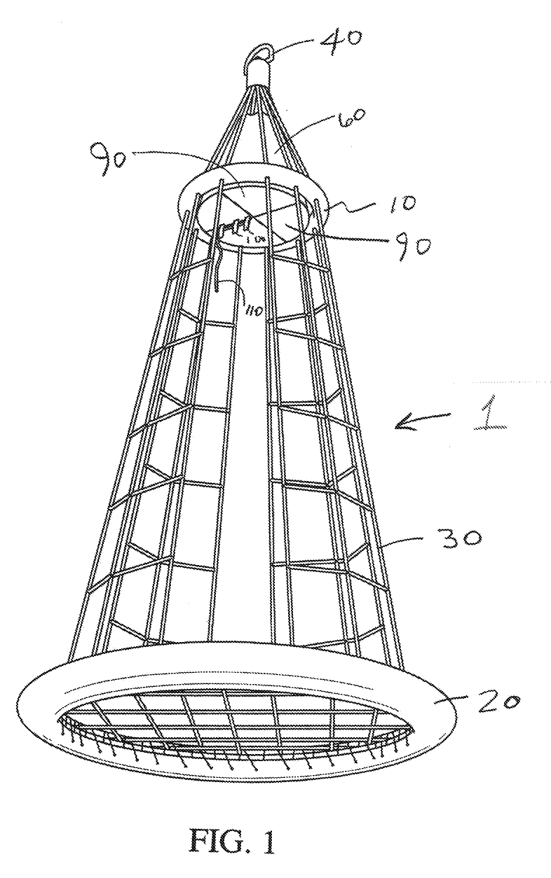

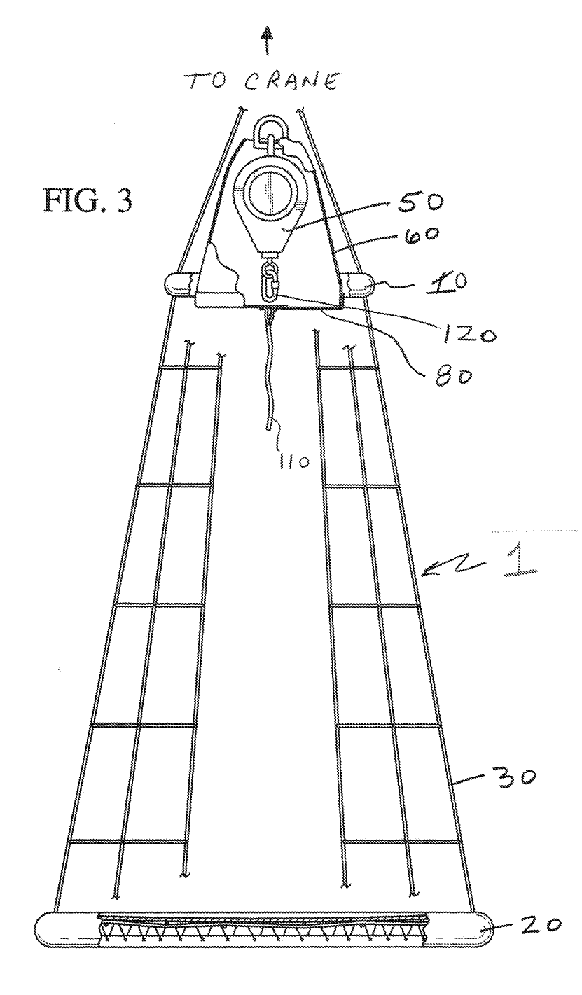

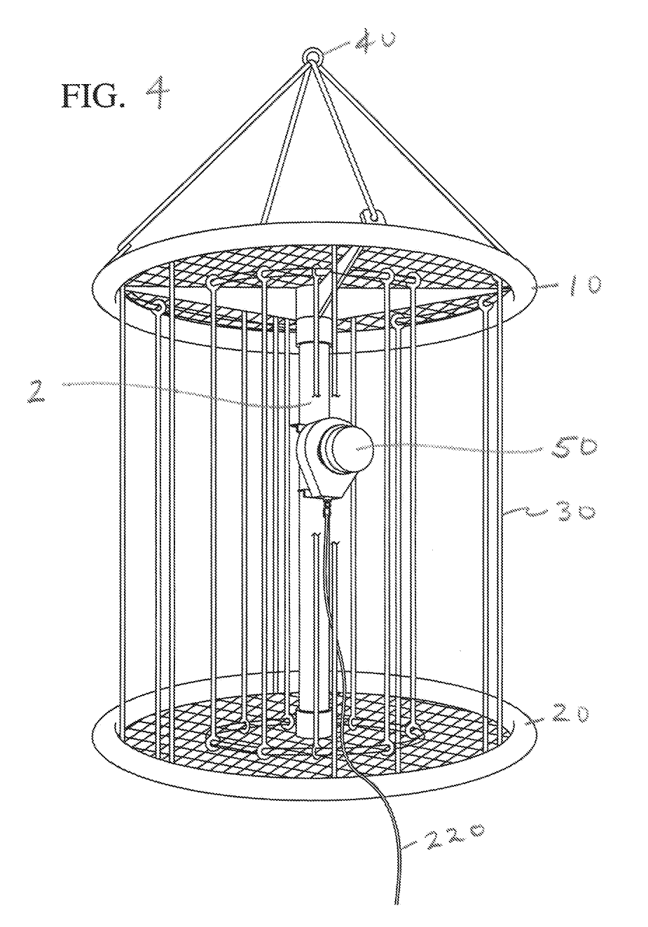

With reference to FIG. 1, a typical personnel transfer device 1 (referred to at times as a personnel basket or personnel carrier) comprises two spaced apart spreader rings 10 and 20, connected by a webbing 30. The basket is suspended by ring 40 from a crane. The use of such baskets, particularly in offshore environments in the oil and gas industry, is well known. As noted above, U.S. Pat. Nos. 2,827,325; 3,827,745; and 4,883,301 disclose various embodiments of personnel baskets or personnel transfer devices; U.S. Pat. Nos. 7,121,600 and 7,252,315 disclose another embodiment, wherein the upper and lower spreader rings are rigidly separated by a rigid member 2. It is to be understood that the same reference numbers are generally used for like elements in FIGS. 1 and 3-5. It is to be further understood that the present invention comprises all forms of personnel baskets, personnel transfer devices, or similar devices used to move personnel from one location to another, between elevated and non-elevated or lower locations.

### Controlled Descent Devices Generally

Broadly, a controlled descent device is a device which releases or pays out a cable or other flexible member in a controlled fashion under a load. In the presently preferred embodiment, controlled descent device 50 is a device which has a cable, rope or other flexible member, typically wrapped on a spool (referred to hereinafter as “cable”), carried inside a housing. A means for releasing the cable in a controlled fashion under a load, for example a braking mechanism, which may be a centrifugal braking mechanism, within the device allows the spool to rotate, and consequently the cable to pay out, only at a controlled rate. A person can therefore attach his body to the device, typically by some sort of harness arrangement, and lower himself at a safe and controlled rate from an elevated position by virtue of his body weight. Once the person is at the lower location, the harness is removed, and a spring inside the device then rotates the spool and retracts the cable into the housing. Such controlled descent devices are known in the art and are commercially available from one or more sources. By way of example, U.S. Pat. No. 6,810,997 discloses a representative device. It is to be understood, however, that the present invention comprises other possible types of controlled descent devices, from which a flexible member such as a rope or cable can be released in a controlled fashion, and is not confined to a or any particular type of braking device or centrifugal braking force device.

In addition, the scope of the present invention encompasses means for lowering personnel in a controlled manner to a lower position, including simply a rope, cable, or other flexible member, referred to broadly as “rope,” hanging off of the personnel transfer device with the lower end proximal a lower location, with the personnel lowering themselves in hand-over-hand fashion to a lower position. Yet another embodiment of the present invention comprises a rope which may be deployed off of the personnel transfer device, with the personnel in a harness coupled to one of various friction apparatus commonly used in rappelling and rock climbing, and commonly known as “descenders” or “rappel devices” that utilize rope friction to provide the controlled descent. The scope of the present invention includes such apparatus in combination with a rope, to permit descent from the personnel transfer device.

The Combined Personnel Transfer Device with Controlled Descent Device of the Present Invention

The present invention combines a personnel transfer device with a means for lowering personnel in a controlled manner, as herein described.

The first embodiment that will be described is a personnel transfer device comprising a controlled descent device, along with additional elements to ensure that the controlled descent device is protected yet readily available when needed.

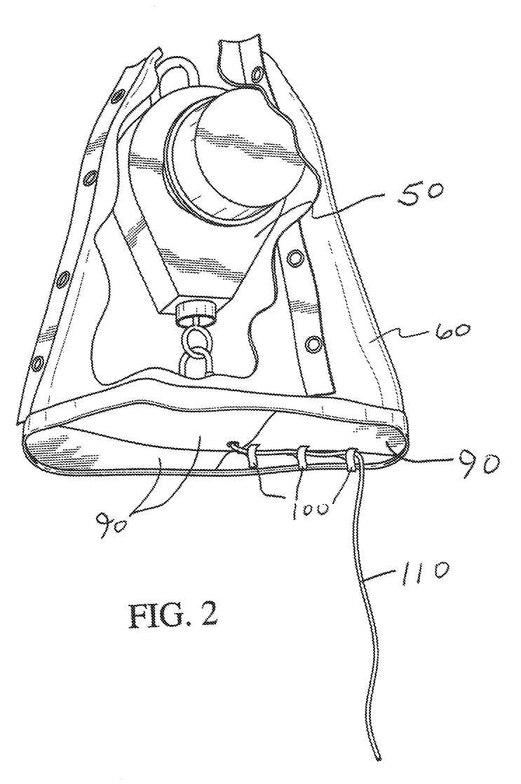

Referring to the drawings: FIG. 1 shows a personnel basket or personnel transfer device, as earlier described. A controlled descent device 50 is fixed within the peak of the basket, preferably within a protective fabric hood 60—see FIGS. 1-3. The bottom of hood 60 is closed by a floor 80 (typically of a rigid, fabric covered material), with bottom flaps 90. Flaps 90 are held closed by one or more breakaway tabs 100. A release rope 110 is fixed to hood 60, such that a strong pull on release rope 110 breaks tabs 100, and pulls down floor 80, exposing controlled descent device 50. One or more harnesses (not shown) are contained within hood 60, and can be accessed once floor 80 is open.

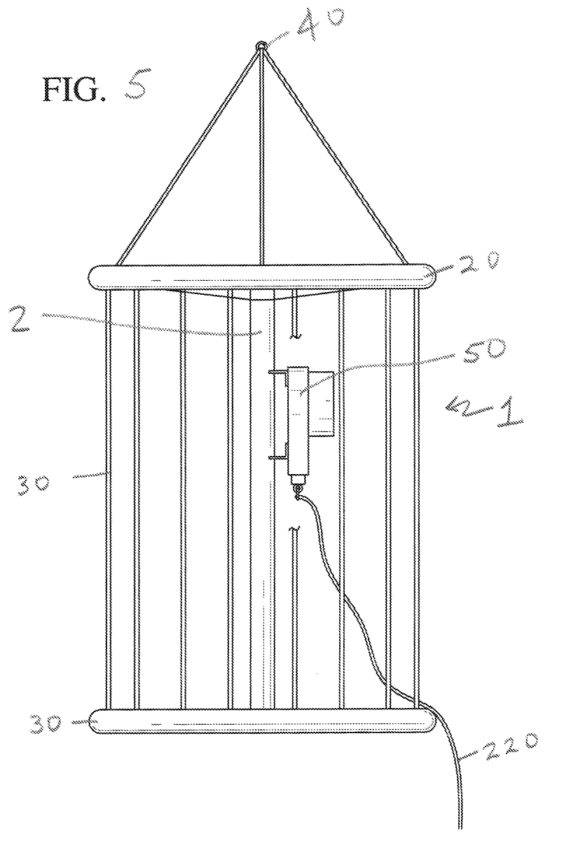

Method of use of the apparatus: a typical method or sequence of use of this embodiment of the apparatus can now be described, under a situation with one or more personnel in the transfer device, and where descent from the transfer device is required. Release rope 110 is pulled, so as to break tabs 100, open flaps 90 and floor 80. Preferably, tabs 100 are serialized, and records are kept so that periodic inspections can be employed to ensure that the controlled descent device has not been tampered with. Once floor 80 is open, harnesses are available. Each person dons a harness. One person then connects his or her harness 200 to the cable from controlled descent device 50, typically by shackle 120 or the like. Then, the person can position himself over the edge of the personnel transfer device, and release his hold thereon, whereby the controlled descent device 50 will lower the person to a lower position, typically the platform, boat, ground, water surface, etc., as can be seen in FIG. 6. Once the person is at the lower position, he unhooks from shackle 120, and controlled descent device 50 pulls the cable 220 and shackle 120 back up (by virtue of the spool therein being spring biased) to the personnel transfer device, for the next person to hook up to his harness and repeat the procedure until all personnel are evacuated. It is to be understood that the term “cable” is used in its broad sense herein, to include any form of rope or cable, whether of wire, natural fiber or synthetic fiber, or flexible member of any sort.

The personnel transfer device in combination with a controlled descent device also comprise a system for personnel movement.

### Another Embodiment of the Invention

FIGS. 5 and 6 show another embodiment of the present invention, comprising another style of personnel transfer device and another mode of mounting the controlled descent device therein.

In FIGS. 5 and 6, personnel transfer device 1 comprises upper and lower spreader rings 10 and 20, with a web of ropes 30 therebetween, but additionally comprises a rigid member 2 connecting the upper and lower rings. In this embodiment, controlled descent device 50 can be mounted on rigid member 2, by means of a clamp or bracket mechanism. In other respects, this embodiment would be used substantially the same as the first described embodiment.

### Additional Embodiments of the Invention

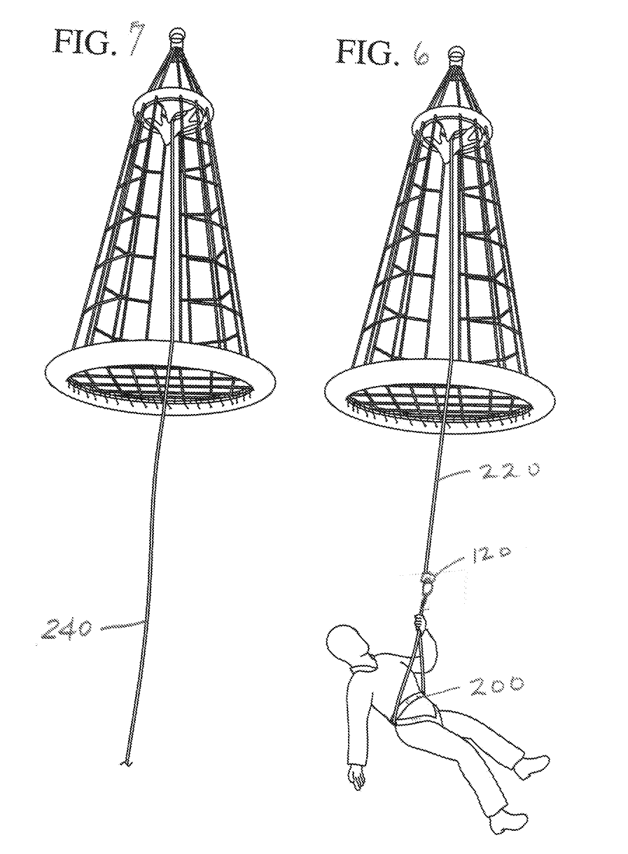

The scope of the present invention comprises a personnel transfer device comprising any means for lowering personnel in a controlled manner from an elevated position. Therefore, in addition to the controlled descent device 50 shown and described above, the present invention comprises a personnel transfer device comprising a rope 240 or similar flexible member, suspended therefrom, down to close proximity to a boat deck or other desired location, as shown in FIG. 7. Personnel can then lower themselves hand-over-hand down the rope, to a boat or other desired location.

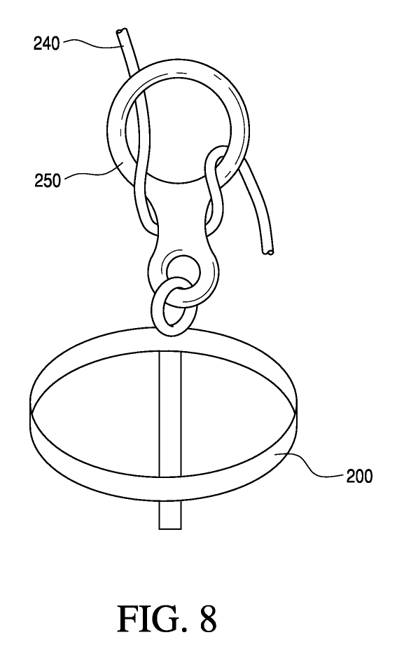

Yet another embodiment of the present invention comprises a personnel transfer device comprising a rope 240 or similar flexible member, suspended therefrom, down to close proximity to a boat deck or other desired location, again as shown in FIG. 7, further comprising an apparatus which utilizes friction forces of the rope passing therethrough to control passage down the rope. Such apparatus are commonly known as a friction device, “descender,” or “rappel device,” and are commonly used in rappelling, rock climbing and the like. By way of example only, one such commercially available device is a so-called “figure 8” device 250, as shown in FIG. 8. As is well known in the relevant art, the user of a friction device such as a rappell device attaches same to a harness 200, operatively connects the friction device 250 to a lowering rope 240 (for example, by routing rope 240 through friction device 250 as in FIG. 8), then lowers himself off of the personnel carrier, with the rope 240 being fed through the friction device 250 at a controlled rate, thereby controlling the rate of lowering of the user.

### Conclusion

While the foregoing description sets out specificities regarding several presently preferred embodiments of the invention, it is to be understood that various changes may be made to the described embodiment while remaining within the scope of the invention. For example, dimensions and materials may be changed to suit particular uses. The invention comprises any sort of personnel basket, personnel carrier, or personnel transfer device, whether collapsible or rigid. The invention may be used in settings other than offshore operations typical in the oil and gas industry; for example, industrial settings such as plants, refineries, etc. where personnel may be lifted to elevated positions. The scope of the invention encompasses any sort of means for lowering personnel in a controlled manner from a personnel transfer device in an elevated position, regardless of the manner by which the controlled lowering is accomplished.

Therefore, the scope of the invention is not limited by the above described embodiments, but by the scope of the appended claims and their legal equivalents.

We claim:

1. A personnel transfer device comprising a means for lowering personnel in a controlled manner from said personnel transfer device in an elevated position, to a lower position.

2. The personnel transfer device of claim 1, wherein said means for lowering personnel in a controlled manner comprises a rope attached to said personnel transfer device and extending to a position proximate said lower position.

3. The personnel transfer device of claim 2, further comprising a friction device engaging said rope, and a harness attached to said friction device.

5. The personnel transfer device of claim 1, wherein said means for lowering personnel in a controlled manner comprises a controlled descent device.

6. The personnel transfer device of claim 5, wherein said controlled descent device comprises a rotating spool, a cable, and a braking system controlling rotation of said spool under the weight of a person supported by said cable, thereby lowering said personnel in a controlled manner.

7. The personnel transfer device of claim, wherein said controlled descent device further comprises a harness attached to said cable, and wherein said personnel is held by said harness during said lowering.

8. A system for personnel movement, comprising:
a personnel transfer device;
a controlled descent device attached to said personnel transfer device, comprising a cable which can be paid out in a controlled fashion; and
a harness connected to said cable.

9. The system of claim 8, wherein said controlled descent device comprises a spool and wherein said cable is wound on said spool, and further comprises a braking system which controls rotation of said spool.

10. A method for safely moving personnel from a personnel transfer device in an elevated position, to a lower position, comprising the steps of:
providing a personnel transfer device comprising a controlled descent device, said controlled descent device comprising a cable, and a harness for attachment to said cable;
with one or more personnel in said personnel transfer device, placing one of said personnel in said harness and connecting said harness to said cable;
moving said personnel in said harness off of said personnel transfer device, whereby said personnel is lowered in a controlled fashion by said controlled descent device to a lower position.

11. The method of claim 10, whereby when one of said personnel reaches said lower position, said harness is removed, and said cable retracts to said personnel transfer device.
